(19) United States
(12) Patent Application Publication
(10) Pub. No.: US 2023/0241550 A1
(43) Pub. Date: Aug. 3, 2023

(54) Hybrid Aqueous Gas Compression/Energy Storage System And Method Supporting Aqueous Gas Separation

(71) Applicant: Gerald C. Blount, Saint Helena Island, SC (US)

(72) Inventor: Gerald C. Blount, Saint Helena Island, SC (US)

(21) Appl. No.: 18/104,955

(22) Filed: Feb. 2, 2023

Related U.S. Application Data
(60) Provisional application No. 63/305,812, filed on Feb. 2, 2022.

(51) Int. Cl. B01D 53/14; B01D 19/00

(52) U.S. Cl. CPC B01D 53/1475; B01D 53/1493; B01D 19/0036; B01D 2252/103; B01D 2257/504; B01D 2258/0283; B01D 2259/45

(57) ABSTRACT

A hybrid aqueous gas separation/gas compression/potential energy storage system designed to be operated in flowing water systems with aqueous gas separation and aqueous downflow compression arranged between upper and lower discharge elevations (water head), or in a simple pump around scenario where circulation is provided by water circulation pumps. The flowing water assists in reducing/eliminating power demand for compression of gases to be separated aqueously and supports circulation within the aqueous gas separation system. The overall system helps support lower cost carbon dioxide (CO2) capture from various sources achieving net-zero-carbon, net-negative-carbon configurations, and beneficial reuse of CO2. The system can be configured on-land (in well/shaft, with circulation pumps, or coupled with pumped storage) or off-shore (partly submerged, using circulation pumps).

### OVERVIEW

A hybrid aqueous gas separation/gas compression/potential energy storage system is described. The system includes aqueous gas separation technology (see, for example, U.S. Pat. Nos. 8,783,371; 9,868,084 Blount, et. al., Jul. 22, 2014, and Jan. 16, 2018, respectively) integrated with downflow aqueous gas compression, and flowing water systems (open or closed loop pumped storage with reversing penstock, hydro-power systems, and flowing water in general, etc.). The system is designed to be operated in flowing water systems with aqueous gas separation and aqueous downflow compression arranged between upper and lower discharge elevations (water head), or in a simple pump around scenario where circulation is provided, for example, by water circulation pumps. The flowing water assists: 1. In reducing/eliminating power demand for compression of gases to be separated aqueously; 2. In supporting circulation within the aqueous gas separation system (flow-through operation or start-up). The overall system can help support lower cost carbon dioxide (CO2) capture from various sources to achieve both net-zero-carbon, net-negative-carbon configurations, and beneficial reuse of CO2. The system can be configured for on-land (in well/shaft, with circulation pumps, or coupled with pumped storage) and off-shore (partly submerged, and/or with circulation pumps).

### FIELD OF THE DISCLOSURE

This disclosure relates to hybrid aqueous gas separation/gas compression/potential energy storage system and to carbon dioxide (CO2) capture from various sources to achieve both net-zero-carbon, net-negative-carbon configurations, and beneficial reuse of CO2.

### BACKGROUND

According to the Intergovernmental Panel for Climate Change (IPCC) it will be necessary to achieve both net-zero-carbon and net-negative-carbon to maintain average planet climate warming to below 2.6C (IPCC, 2021).

FIG. 1 illustrates IPCC Earth warming ranges under various CO2 release scenarios, both positive and negative, (1-1.9C, 1-2.6C, 2-4.5C, 3-7.0, 5-8.5C); with net-zero-carbon by˜2055 and net-negative-carbon afterwards at a rate of over 10 billion metric tons/year. The wide range of potential warming is due to modeling uncertainties, but the high end is more likely than the lower end of the range (Zhu et al, 2020). The IPCC has leaned heavily on bioenergy with carbon capture and storage (BECCS) to achieve negativity in past studies (IPCC, 2018).

Achieving low-cost carbon dioxide (CO2) capture is difficult. The aqueous gas separation systems noted above (using downflow counter-current cascading absorbers) can significantly reduce the cost of CO2 capture. A major capital and operating cost component in aqueous gas separation is equipment size, cost, and energy demand for pressurizing the gases to be separated.

### SUMMARY OF THE PRESENT INVENTION

One goal of this invention is to reduce the size and cost of mechanical compression systems and to significantly reduce the energy demand for pressurizing gases being worked with during aqueous gas separation.

Another goal is to integrate the necessary energy demand to fit well with the likelihood of excess power on the grid from renewables (using mostly energy during off-peak demand).

This specification outlines the use of a down-flow aqueous gas compression system. Integration of down-flow aqueous compression linked to flowing water provides an opportunity to reduce the scale and energy demand of mechanical gas compression systems, and further supports potential flow-through operation or startup circulation for aqueous gas separation. A simple pump through mode of circulation for aqueous compression and gas separation employing circulation pumps (preferably at low lift) yields a˜50% reduction in power demand over mechanical compression. The reduced power demand is because water can be pumped at great efficiency since it is not compressible (unlike gas compression).

The use of pumped storage configurations provides an energy storage component to the flow-through operation, and an opportunity to both capture CO2 and store power. In a 12-hour off-peak and 12-hour on-peak scenario the water flow component of the system could be charged and discharge over a 24 hour period yielding CO2 capture over the full 24 hours.

Because the terminal rise velocity of bubbles in water is generally low (less than 1 meter per second), it is possible to achieve aqueous compression with low water head. FIG. 2. Illustrates curve flattening in the terminal rise velocity of bubbles (diameter in mm vs. velocity in cm/s) in different bubble regimes, for example, in water (Park et al, 2017). Specifically, gases are introduced as bubbles into downward flowing water within a tube where the velocity of the water is greater than the rise velocity of the bubbles. In this situation the bubbles are carried downward, initially slowly, but accelerating with increased hydrostatic pressure (bubbles become smaller and less buoyant as compressed). As the bubbles are carried downward to the desired pressure (hydrostatic) the pressure within the bubbles is equal to the hydrostatic pressure.

Upon bubble disengagement and capture from the downward flowing water the compressed gases can be piped to the surface through conduits or piping provided in the well/shaft, or in a similar manner to a surface operation in an offshore setting. The intent of use is with aqueous gas separation (gases must be compressed for entry into the aqueous absorber), but there may be many uses for the compressed gases. The configuration of the aqueous compression system will be discussed in further detail in later sections.

In physics, water flow velocity versus hydraulic head is a very well understood and can be calculated with Bernoulli's maximum velocity equation (V=sqrt [2gh]; where V=velocity, g=gravity, h=head). Per Bernoulli's equation, relatively low head can achieve sufficient water velocity to overcome bubble rise and provides more opportunity for application world-wide. Typically, 2% land gradient or greater is sufficient to construct an economic system with enough hydrostatic head to achieve water velocities significantly greater than the bubble rise velocity. Because compression is the intent (not mass transfer) with respect to mixing gases with water, the bubble fraction can be very high (70 to 75%). Large bubble fractions support greater gas compression tonnage. The gas entry depth into the flowing water can be via vacuum venturi, or as a sparging system where moderately compressed gases are introduced at depth within the slipstream. Sparging provides the opportunity to use the least amount of compression energy yet maximize gas compression tonnage.

Gas separation assisted by aqueous compression can be achieved if water is flowing, for example by employing circulation pumps, or in a pumped storage scenario and this takes advantage of the economics of off-peak versus on-peak power. The overall hybrid system has valving in a pumped storage scenario to support flow-through when a reversing penstock is operating in either direction. This condition has good potential to fit well with renewable power, and grid load stability.

The aqueous compression can be operated in one or a series of columns to maximize the gas compressed with the lowest volume of water (water going from one column to the next). This type of aqueous compression arrangement can be used in reservoir flooding and produced water disposal situations associated with oil and gas reservoirs where the pumped water volume might not be as large as hydro-power situations.

When implemented with CO2 from fossil carbon sources of process/flue gas this hybrid system can assist in net-zero-carbon. When implemented with CO2 from biologically derived carbon sources of process/flue gas this hybrid system can assist in net-negative-carbon.

### Description Of Presently Preferred Examples Of The Invention

### BRIEF DESCRIPTION OF FIGURES

The invention is better understood by reading the following detailed description with reference to the accompanying drawings in which:

FIG. 1 illustrates IPCC Earth warming ranges under various atmospheric CO2 loading scenarios, both positive and negative (IPCC, 2021).

FIG. 2 shows terminal rise velocity of bubbles (diameter in mm vs. velocity in cm/s) in different bubble regimes (Park et al, 2017).

FIG. 3 shows process/flue gas scenario using pumped storage as “water flow” to support downflow aqueous gas compression coupled to aqueous gas separation.

FIG. 4 shows Internal combustion fossil fuel generation scenario using pumped storage as “water flow” to support downflow aqueous gas compression coupled to aqueous gas separation.

FIG. 5 shows Internal combustion generation with bio-derived fuel using pumped storage as “water flow” to support downflow aqueous gas compression coupled to aqueous gas separation.

FIG. 6 shows In-well aqueous compressor with gas entry near atmospheric pressure (via venturi); and

FIG. 7 shows In-well aqueous compressor with gas entry under pressure (via sparge).

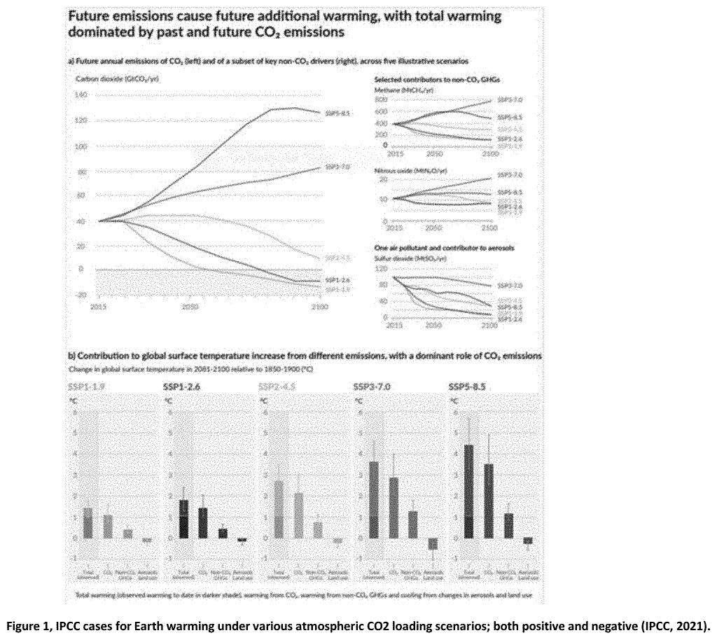

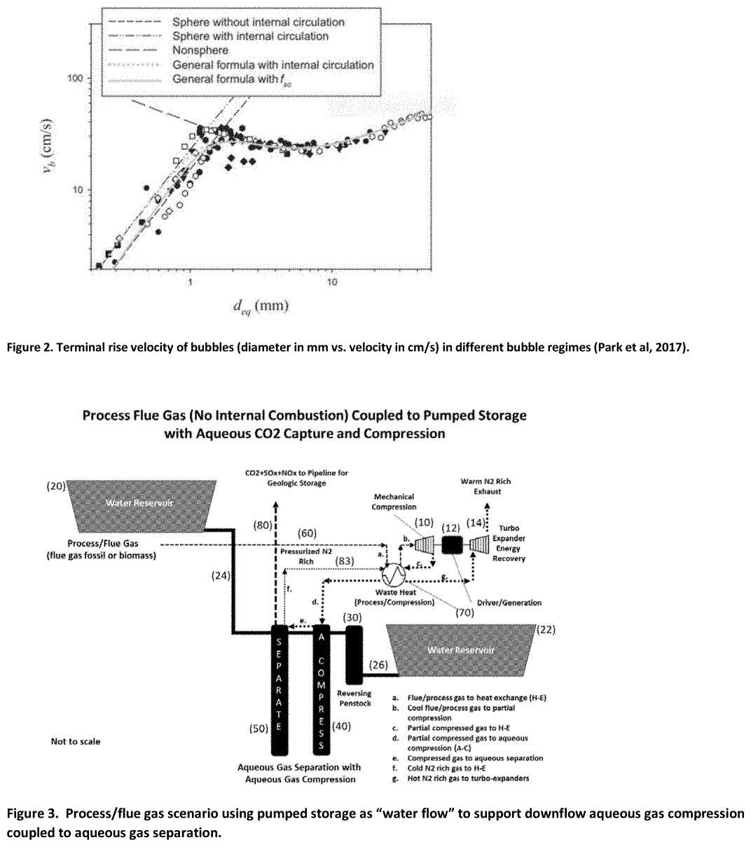

### DETAILED DISCUSSION OF APPLICATION FOR AQUEOUS COMPRESSION LINKED TO AQUEOUS CO2 SEPARATION

Because application to net-zero-carbon and net-negative carbon is critical, three application scenarios are provided that can be illustrated as follows: (1) existing fossil/biomass combustion or other flue gas releasing processes (net-zero-carbon), (2) fossil fuel internal combustion with generation (net-zero-carbon), and (3) bio-derived fuel upgrade and internal combustion generation (support net-negative-carbon). Beneficial reuse of captured CO2 is applicable with CO2 product gas for any of the scenarios.

FIG. 3. illustrates the system implemented with pumped storage for process/flue gas. Although the system could have independent water pumps within each well/shaft to support water circulation. Detailed valving is not shown to support flow through the “compressor then aqueous gas separation” in either direction with a pumped storage scenario. This valving is well understood. FIG. 4. Shows a similar system with internal combustion (turbine), and fossil fuel.

In FIG. 3 there is a first water reservoir 20 and a second reservoir 22 with one water flow line or conduit 24 connected to reservoir 20 and another water flow line or conduit 26 connected to reservoir 22. The system also includes a compressor 10, a driver or generator 12, a turbo expander 14, a reversing penstock 30, a compressing column 40, and a separator column 50. The water can flow either from reservoir 20 to 22, where the penstock 30 will be generating power, or from reservoir 22 to 20 where the penstock 30 operates as a pump to move the water.

Regardless of which way the water is flowing between reservoirs 20 and 22, water will first flow into the compressing column 40 in which downward flowing water carries gas to be compressed, then via line e to the separator column 50 and then to the opposite reservoir via a conduit 24.

Process/flue gas 60, which can be hot, is fed via line a to a heat exchanger 70 to heat pressurized N₂ rich gas flowing via line f from the separator column 50 which is passed into the mechanical compressor 10 via pipe b, and to heat exchanger (70) via pipe c, then conveyed by line d into the compressing column 40 where partially compressed gas is mixed with incoming water for further compression. Line g transports hot pressurized expanded gas from the top of the absorber or separator 50, via line f through heat exchange via line 83, to the turbo expander 14 and warm N₂ rich gas is exhausted to the atmosphere. Turbo expander 14 drives power generation which offsets power consumed by compressor (10).

Compressed gas (via pipe e) and water then flow from compressing column 40 into the separator column 50 where CO₂, SOx, NOx, and other gases are separated out from the water and can be collected and sent via line 80 to suitable storage, for example geologic storage.

FIG. 4 shows an internal combustion fossil fuel generation scenario using pumped storage as “water flow” to support downflow aqueous gas compression coupled to aqueous gas separation. FIG. 4 is similar to FIG. 3, except there is a source of fossil fuel arriving via conduit 60 and the addition of internal combustion generator (16), also having a supply of air via line 21, and a driver/generator (12), with high temperature waste heat used to exceed the compression energy demand (via heat exchange 70) from the mechanical compressor (10) combined with the turbo expander (14) linked to driver/generator 12. This waste heat use makes the energy recovery potentially net positive by expanding the N₂ rich gases exiting from the top of the absorber/separator 50, exiting from the separator system via line f, and piped to the heat exchange (70) via line 83, hot gas is piped to expander 14 via pipe g. Energy depleted gases are then discharged to the atmosphere.

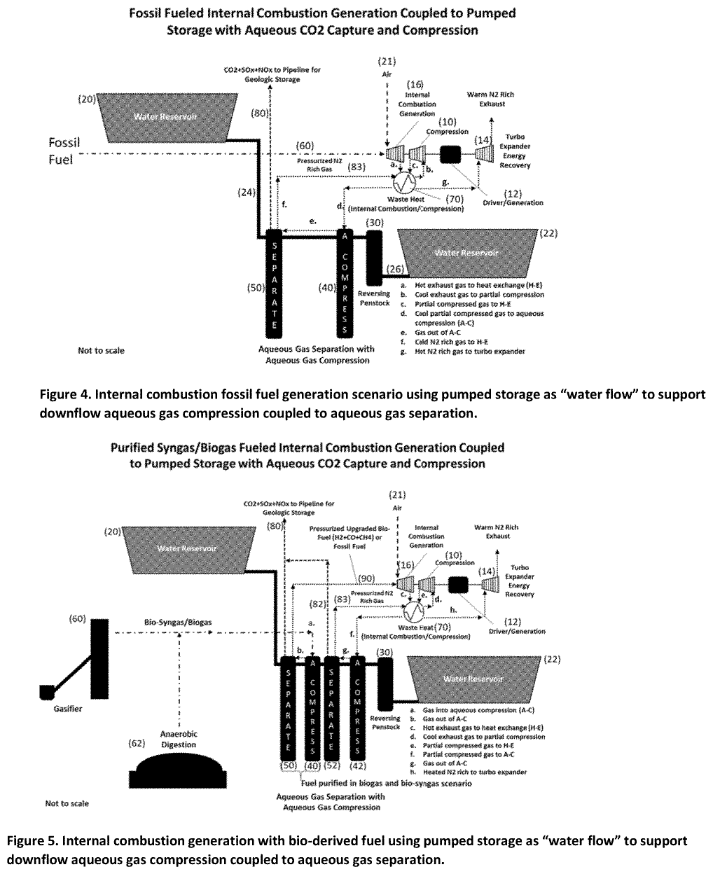

FIG. 5 illustrates internal combustion generation with bio-derived fuel using pumped storage as “water flow” to support downflow aqueous gas compression coupled to aqueous gas separation. This scenario supports purification of the bio-derived fuel (CO2, SOx, removal) and separation of gases from the internal combust exhaust (CO2, SOx, NOx separated from N2, Ar, O2, etc.).

In this FIG. 5 there are still two water reservoirs 20 and 22 and the flow will be similar to that described above for FIGS. 3 and 4. However, this system incorporates and additional set of a compressing column 42 and an additional separator column 52. Water flow will be first to column 40 where water along with a supplied volume of Bio-syngas or Biogas from a gasifier 60 or from another source, for example, an anerobic digestor 62. Down flowing water in compressing column 40 and the entrained gas will undergo aqueous compression therein and flow will then proceed to the separator column 50 via line b from which acid gases like CO₂, SOx, will have been separated out and sent to geologic storage via line 80. Also coming from separator column 50 is pressurized upgraded biofuel in the form of H₂, CO and CH₄, or fossil fuel, that is flowing via line 90 to turbine 16.

From separator column 50 the water will then flow to compressing column 42, which is also receiving hot partially compressed gas from heat exchanger 70 via line f. Gas entrained in the water flow into compressing column 42 is again aqueously compressed and will then flow to separator column 52 where additional gases, such as CO₂, NOx and SOx are further separated and sent to storage via line 82 and line 80. Water will flow from separator 52 back to one of the reservoirs.

Gas from separation (line 83) enters heat exchanger (70) and is directed to the mechanical compressor 10 via pipe d, and exits the mechanical compressor 10 via pipe e. Waste compression heat can be captured with heat exchanger 70. Partially compressed gas exits heat exchanger (70) and enters aqueous compression via line f Fully compressed gas exits the aqueous compressor via line g where the gas enters separation 52. Acid gases are discharged from separation via line 82, non-acid gases exit separation via line 83.

### DISCUSSION OF AQUEOUS COMPRESSION

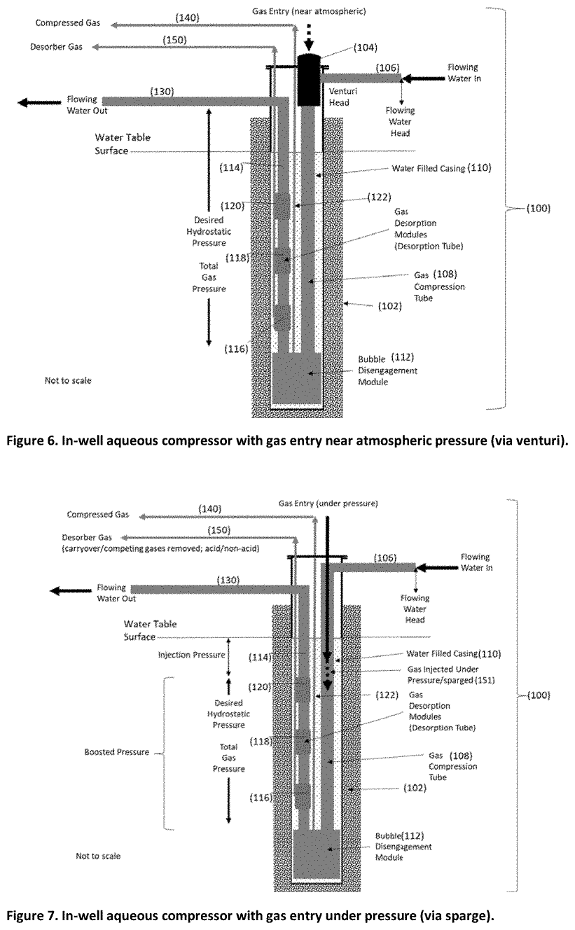

FIGS. 6 and 7 showing the downflow aqueous compressor according to this present invention installed on-land in a shaft/well. It should be understood that it is also possible to operate the system in an offshore scenario, for example, on or as a part of an offshore platform or as a standalone installation. FIG. 6 illustrates the gas entry at near atmospheric. FIG. 7 illustrates the gas entry with partial compression (added gas compression mass) into the flowing water at depth (higher hydrostatic pressure).

The general system is comprised of a compression tube, a bubble disengagement module, a desorption tube, and one or more desorption gas disengagement modules.

The system 100 is comprised of a downhole structure 102 that can be either on land or as a part of a deep-water location. A gas can be introduced at near atmospheric pressure by means of a venturi structure 104 and water can flow in via a line 106 and the two, water and gas, will be mixed together. The water flows down a gas compression tube 108 to the bottom and into a bubble disengagement module 112. The gas compression tube 108 can be positioned internally within the down hole structure 102 and surrounded by a water filled casing 110, with water extending from the water table surface to the desired hydrostatic depth (desired compression pressure). This water configuration eliminates the potential for water to enter/exit the casing (in ground) because there is no head difference. Two conduits, one shown at 122 is for carrying gas, and a second at 114 is for carrying a combination of water and dissolved gas, extend upwardly out of the bubble disengagement module 112. Conduit 122 feeds into a compressed gas line 140 for discharge to other aqueous separation devices or to another desired mechanism/process.

Conduit 114 includes a plurality of vertically spaced apart gas desorption modules 116, 118 and 120, where effervescing gases (non-acid and acid) are collected and moved through a pipe 150 for delivery to another separation system or to another desired mechanism/process (looped to compression or directed to energy recovery).

In summary, the operation of FIG. 6 is a follows:

1. Water is introduced into the system (flowing water in),

2. The compression tube contains the downflowing gas/water mixture that is carried by the elevation difference (hydrostatic head) across the system or in a pumped mode.

3. The gas/water mixture enters the bubble disengagement module where the water and gas are separated.

4. Water reverses direction from downflow to up-flow in the desorber.

5. The desorption tube and desorption modules support effervescence of dissolved gases (as water flows from higher to lower hydrostatic pressure) and capture/management of the gases (desorber gas).

6. Additional components are a venturi head (FIG. 6 example) when managing gases near atmospheric, and a gas sparger (where is this shown in the Figs?)

FIG. 7 operates in a manner similar to FIG. 6, but the gas exiting internal combustion device is partly pressurized, ranging from about 5 to about 10 bar, for example, or can be pressurized by another compression system. It is possible to use a mechanical compressor or a series of aqueous compressors to achieve partial compression of that incoming gas that will exceed the hydrostatic pressure of the discharge point 151 shown at the dotted line in gas compression tube 108. The increase in pressure by the aqueous compressor can be “whatever is desired to the point of what is constructible” (from a few atmospheres to perhaps 60 bar). The pressure required for the separation system (50) is a function of temperature but is likely 20 bar or more via pipe e. Entry pressure into the aqueous compressor (40) is dependent upon the capacity boost needed but is likely 5 bar or more (entry of 5 bar and exit of 20 bar would roughly yield an energy demand and cost reduction of 75%).

The use of flowing water to support compression and gas separation also has an advantage of potentially lowering the temperature of the overall water-gas interactions, and inter and after cooling of mechanical compression (process/flue gas or engine exhaust, and CO₂ product compression).

It should be noted that waste heat from engines (reciprocating and turbines) can be very useful in energy recovery as illustrated in FIGS. 3 through 5. Where power demand is reduced with waste heat using pressurized reject gases from the aqueous gas separation system previously noted above where waste heat is used to expand cooler pressurized gases which are applied to turbomachines to support power generation.

When introducing elements of various aspects of the present invention or embodiments thereof, the articles “a,” “an,” “the” and “said” are intended to mean that there are one or more of the elements, unless stated otherwise. The terms “comprising,” “including” and “having,” and their derivatives, are intended to be open-ended terms that specify the presence of the stated features, elements, components, groups, and/or steps, but do not exclude the presence of other unstated features, elements, components, groups, and/or steps and mean that there may be additional features, elements, components, groups, and/or steps other than those listed. Moreover, the use of “top” and “bottom,” “front” and “rear,” “above,” and “below” and variations thereof and other terms of orientation are made for convenience, but does not require any particular orientation of the components. The terms of degree such as “substantially,” “about” and “approximate,” and any derivatives, as used herein mean a reasonable amount of deviation of the modified term such that the end result is not significantly changed. For example, these terms can be construed as including a deviation of at least +1/−5% of the modified term if this deviation would not negate the meaning of the word it modifies.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim:

1. A hybrid aqueous compression system supplying compressed gases to an aqueous CO₂ capturing device to obtain a net-zero-carbon or net-negative-carbon reducing atmospheric CO₂ when suitably stored comprising:
a downflow system incorporating a source of in-flowing water directed into a depending gas compression structure;
a gas introduction system to feed a desired gas into the in-flowing water and into the depending gas compression structure to compress entrained gas into the flowing water;
a bubble disengagement module positioned adjacent a bottom of the device operatively connected to the depending gas compression structure and receiving the water and compressed gas;
a compressed gas discharge line in fluid connection with the bubble disengagement module to export non-acidic gases as a compressed gas; and
a water out-flow line operatively connected to the bubble disengagement module through which water is discharged, the water out-flow line further including a plurality of gas desorption modules at spaced apart locations there along to separate CO₂ from the remaining gases with at least a lowermost gas desorption module removing non-CO₂ gases and the remaining ones of the plurality of gas desorption modules removing increasingly greater volumes of CO₂ gas.

2. The hybrid aqueous compression system as in claim 1 wherein the gas introduction system introduces gas at near-atmospheric conditions.

3. The hybrid aqueous compression system as in claim 1 wherein the gas introduction system introduces gas that has been at least partially compressed.

4. The hybrid aqueous compression system as in claim 1 further including a hydro power storing system providing water flow.
